(19) United States
(12) Patent Application Publication
(10) Pub. No.: US 2026/0244440 A1
(43) Pub. Date: Aug. 20, 2026

(54) System and Method for Program State Relevancy Assessment

(71) Applicant: Diffblue Limited, London (GB)

(72) Inventors: Paul Crane, Oxford (GB); Johannes Kloos, Oxford (GB); Romain Brenguier, Bath (GB)

(21) Appl. No.: 19/056,623

(22) Filed: Feb. 18, 2025

(51) Int. Cl. G06F 8/75

(52) U.S. Cl. CPC G06F 8/75

(57) ABSTRACT

A method comprising identifying, by one or more processors, a plurality of sets of input values for one or more input parameters of a first code block; processing, by the one or more processors, the first code block in accordance with each of the plurality of sets of input values thereby generating a plurality of program states; analysing, by the one or more processors, the plurality of program states to identify a relevant program state generated according to one or more sets of input values of the plurality of sets of input values; and causing, by the one or more processors, an action in relation to the first code block to be executed based on the relevant program state and/or the one or more sets of input values

### TECHNICAL FIELD

The present disclosure relates to dynamic analysis of software. Particularly, but not exclusively, the present disclosure relates to dynamic analysis of software to identify relevant program states based on information content. More particularly, but not exclusively, the present disclosure relates to executing, generating, or modifying software based on the information content of a dynamically generated program state.

### BACKGROUND

Computer programs (e.g., software, software code, etc.) can be analysed either statically or dynamically. Static analysis involves analysing the computer program without execution. For example, a linter may use rule-based checking to identify syntax errors, potential bugs, or deviations from best practice within the source code of a computer program. Dynamic analysis involves observing the runtime behaviour of the computer program. Dynamic analysis typically involves executing the software multiple times across a range of different inputs to generate multiple different program states from which inferences about the computer program can be made. In many real-world settings, the number of inputs required to obtain a meaningful analysis is large leading to an excessively large number of possible program states. Processing and analysing such a large number of program states is inefficient, time consuming, and computationally costly.

There is therefore a need for improved methods for program state analysis.

### SUMMARY OF DISCLOSURE

According to an aspect of the present disclosure there is provided a method comprising: identifying, by one or more processors, a plurality of sets of input values for one or more input parameters of a first code block; processing, by the one or more processors, the first code block in accordance with each of the plurality of sets of input values thereby generating a plurality of program states, wherein a respective program state of the plurality of program states comprises one or more outcomes associated with an invocation of the first code block using a respective set of input values for the one or more input parameters of the first code block; analysing, by the one or more processors, the plurality of program states to identify a relevant program state generated according to one or more sets of input values of the plurality of sets of input values, wherein the relevant program state comprises one or more outcomes which satisfy a surprisal criterion with respect to the one or more sets of input values; and causing, by the one or more processors, an action in relation to the first code block to be executed based on the relevant program state and/or the one or more sets of input values.

According to a further aspect of the present disclosure there is provided a device comprising one or more processors and a memory storing instructions which, when executed by the one or more processors, cause the one or more processors to: identify a plurality of sets of input values for one or more input parameters of a code block; process the code block in accordance with each of the plurality of sets of input values thereby generating a plurality of program states, wherein a respective program state of the plurality of program states comprises one or more outcomes associated with an invocation of the code block using a respective set of input values for the one or more input parameters of the code block; analyse the plurality of program states to identify a relevant program state generated according to one or more sets of input values of the plurality of sets of input values, wherein the relevant program state comprises one or more outcomes which satisfy a surprisal criterion with respect to the one or more sets of input values; and cause an action in relation to the code block to be executed based on the relevant program state and/or the one or more sets of input values.

According to an additional aspect of the present disclosure there is provided a non-transitory computer readable medium storing instructions which, when executed by one or more processors, cause the one or more processors to: identify a plurality of sets of input values for one or more input parameters of a code block; process the code block in accordance with each of the plurality of sets of input values thereby generating a plurality of program states, wherein a respective program state of the plurality of program states comprises one or more outcomes associated with an invocation of the code block using a respective set of input values for the one or more input parameters of the code block; analyse the plurality of program states to identify a relevant program state generated according to one or more sets of input values of the plurality of sets of input values, wherein the relevant program state comprises one or more outcomes which satisfy a surprisal criterion with respect to the one or more sets of input values; and cause an action in relation to the code block to be executed based on the relevant program state and/or the one or more sets of input values.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF DRAWINGS

Embodiments of the present disclosure will now be described, by way of example only, and with reference to the accompanying drawings, in which:

FIG. 1 shows a method for program state relevancy assessment according to an aspect of the present disclosure;

FIG. 2 shows an illustrative example of program state relevancy assessment according to embodiments of the present disclosure;

FIGS. 3A and 3B show an illustrative example of program state relevancy assessment for assertion selection according to embodiments of the present disclosure;

FIG. 4 shows a system for program state relevancy assessment according to an aspect of the present disclosure; and

FIG. 5 shows an example computing system for carrying out the methods of the present disclosure.

### DETAILED DESCRIPTION

Embodiments of the present disclosure will be now described with reference to the attached figures. It is to be noted that the following description is merely used for enabling the skilled person to understand the present disclosure, without any intention to limit the applicability of the present disclosure to other embodiments which could be readily understood and/or envisaged by the reader. In particular, whilst the present disclosure is primarily directed to dynamic analysis of software, the skilled person will readily appreciate that the systems, methods, and devices of the present disclosure are applicable to other areas of software and test development.

A key problem with dynamic analysis is dealing with the sheer number of program states. For example, an “if” statement which checks the state of a single variable has two possible program states; one for each condition. Each additional condition added to the if statement increases the number of states by a factor of two (two variables result in four states, three variables result in eight, four in sixteen, and so on). This is known as the branch explosion problem. The scale of the problem becomes worse as you introduce different data types. For example, there are approximately 4 billion values a 32-bit int type can take on, while a String type is bounded only by the memory limitations of the computer. To analyse a program effectively, a heuristic is needed to prioritise analysis of some states over others to avoid performing expensive analysis on trivially different program states.

The present disclosure is directed to the efficient identification of relevant program states for further analysis based on the information content- or surprisal—of a program state. Analysing a set of different program states in this manner provides an efficient way of identifying surprising program states which can be used as a heuristic for further analysis, code generation, and/or execution.

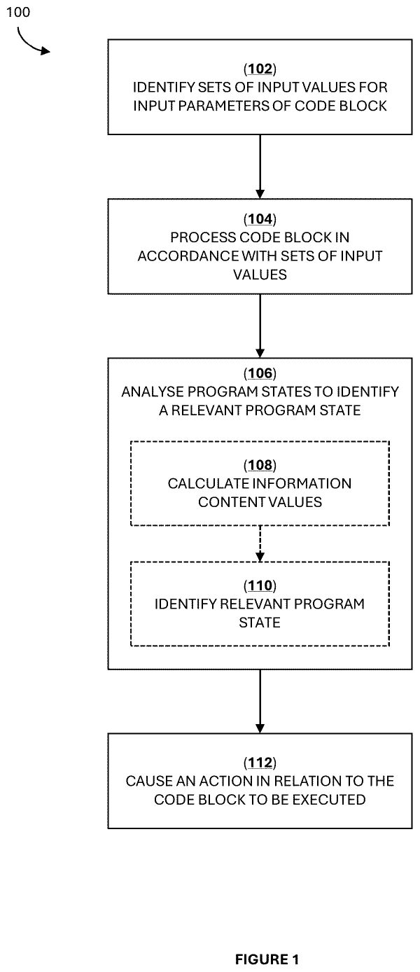

FIG. 1 shows a method 100 for program state relevancy assessment according to an aspect of the present disclosure.

The method 100 comprises the steps of identifying 102 sets of input values for input parameters of a code block, processing 104 the code block in accordance with the sets of input values, and analysing 106 the resulting program states to identify a relevant program state. In one embodiment, the step of analysing 106 the resulting program states comprises the steps of calculating 108 information content values and identifying 110 the relevant program state. The method 100 further comprises the step of and causing 112 an action in relation to the code block to be executed.

Advantageously, the method 100 provides a computationally efficient approach to identify relevant program states and/or input values which can form the basis for more computationally expensive testing and/or analysis. Moreover, the method 100 may automatically and efficiently generate new code or modify existing code based on the identification of relevant program states and/or input values.

At the step of identifying 102, a plurality of sets of input values for one or more input parameters of a first code block are identified.

A code block refers to a portion or section of source code of a computer program which is treated as a single unit. Here a computer program (alternatively referred to as software, software program, or piece of software) is understood to be a set of instructions or code written in a programming language that directs a computer to perform specific tasks or operations. These instructions are executed by one or more processors (e.g., the computer's central processing unit) to achieve desired outcomes, such as data processing, computation, or control of hardware devices. A computer program can range from simple scripts to complex systems and may include various components such as algorithms, data structures, functions, and user interfaces. The functionality of the computer program is defined by its source code, which can be compiled or interpreted to produce executable code that the computer can run. Whilst the present disclosure primarily comprises source code examples in the Java programming language, the skilled person will appreciate that the present disclosure is not limited solely to the Java programming language, nor is it limited solely to a particular programming paradigm such as object-oriented programming. Indeed, the present disclosure is applicable to any suitable compiled or interpretive programming or scripting language including but not limited to Java, C, C++, any suitable assembly language, Python, C#, JavaScript, Ruby, PHP, and the like.

Typically, a code block comprises a plurality of contiguous statements or lines of source code (or intermediate representations thereof such as Java bytecode, LLVM bitcode, etc.) within a computer program which relate to a specific operation or functionality at a level of granularity. For example, at the highest level of granularity, a code block may comprise all statements within the source code of a computer program such that the code block relates to the functionality of the entire computer program. At a finer level of granularity, a code block may comprise all statements within a function or method such that the code block relates to the operation or functionality of the function or method. A code block can thus be understood as a grouping of related statements within the source code of a computer program. A code block in relation to a computer program thus corresponds to one of: one or more statements/instructions or lines of source code of the computer program; a contiguous set of statements/instructions or lines of source code of the computer program; a method, procedure, or function in the source code of the computer program; a class or module in the source code of the computer program; a subset set of statements/instructions or lines of source code of the computer program; or all statements/instructions or lines of source code of the computer program. In one embodiment, the first code block corresponds to a procedure under test of a software program.

One or more statements within a code block are parametrized by a set of values. A parameter corresponds to a portion of the code block which can be parameterized by a value. Examples of parameters within the context of a code block include variables, attributes, arguments, and the like. In the case of a procedure (method or function), the input parameters of the code block correspond to the input parameters of the procedure and a set of input values correspond to values provided to the input parameters. For example, the procedure transferToDMA(byte[ ] OAMBuffer, bool ignoreNMI) has two input parameters (a byte array and a boolean) and a set of input values for the procedure would thus comprise an array of byte values and a Boolean value. The set of input values can thus comprise one or more of: values of instance variables, values of static variables, and/or object references.

An input parameter typically has a corresponding type which restricts the possible values assignable to the input parameter (e.g., restricts the range of possible values). Example types include primitive types such as int, double, bool, etc. and reference types such as String, Object, arrays, etc.

The plurality of sets of input values are identified using a sampling strategy. In general, a sampling strategy determines a set of one or more values for an input parameter. In one embodiment, the sampling strategy comprises sampling values across the range of possible values for the one or more input parameters. For example, an input parameter of type short has a range of possible values from −32,768 to 32,767 and a sampling strategy may generate or return one or more values within this range of possible values. For input parameters having a primitive data type, the range of possible values is determined/restricted by the primitive data type (e.g., for a bool parameter the range of possible values is [False, True], for a signed char parameter the range of possible values is [−128, 127], etc.). For reference types, heuristics and/or reference values can be used to define the range of possible values. For example, a simple heuristic used to determine the possible values for a String input parameter may define a possible value as being a string of any alphanumeric characters of a set length (e.g., 10 characters, 20 characters, etc.). As an alternative example, a list or database of example strings may define the set of all possible values for a string. For compound types, such as objects, the range of possible values for the object can be defined as the combination of the ranges of possible values for all instance variables of the object. For example, an object which has two instance variables of type short and byte, has a compound range of possible values of ([32,768, 32,767], [−128, 127]). A sampling strategy may then generate a possible value for the object by creating a concrete instance of the object with values for the two instance variables determined according to each instance variable's range of possible values.

The sampling strategy can be a random sampling strategy where each value within the range of possible values has an approximately equal chance of being selected. Typically, a random sampling strategy is implemented via the use of a random number generator (or pseudo-random number generator) which is operable to generate a random value from within the range of possible values. For reference types, an element from a set of example elements for the input parameter can be randomly selected according to the value generated by the random number generator, or the random number generator can be used to drive the heuristic for determining possible input values for the input parameter (e.g., to generate a random string of a predefined length).

Alternatively, the sampling strategy can be a systematic sampling strategy where values are sampled at regular intervals from the range of possible values. A systematic sampling strategy can be seeded with a starting value (e.g., a random value within the range of possible values) and then return values by sampling at regular intervals from the starting value. For example, the systematic sampling strategy may be seeded with the value 3 and be configured to return samples with interval size 5 such that the sampling strategy returns values 8, 13, 18, etc.

Alternatively, the sampling strategy can be a stratified sampling strategy where the range of possible values is divided into strata (sub-ranges) and samples taken from each strata. The strata can be defined by dividing the range of possible values into equal parts. Alternatively, the strata can be defined according to a configuration or heuristic. For example, a user may define the strata by defining the values of the strata or the endpoints of the strata. Therefore, if the range of possible values is divided in K strata, then this helps ensure that if a set of K input values for the input parameter are generated then at least one value from each of the strata is included in the set of input values.

Alternatively, the sampling strategy can be a weighted sampling strategy where values are sampled based on a probability distribution that assigns different values to different values. Particular values, or ranges of values, can be weighted more highly than other values, or ranges of values, such that the probability of selecting the more highly weighted values is greater than for the lower weighted values.

In another embodiment, the sampling strategy comprises sampling values dynamically derived from previous sampling results. That is, the information content of a large number of previous program states (as described in more detail below) and the input values used to generate the previous program states form a distribution which can be sampled from, using any of the above-described sampling strategies, to determine input values.

At the step of processing 104, the first code block is processed in accordance with each of the plurality of sets of input values thereby generating a plurality of program states. A respective program state of the plurality of program states comprises one or more outcomes associated with an invocation of the first code block using a respective set of input values for the one or more input parameters of the first code block.

For example, if a code block has a single input parameter and input values of [0, 1, 10, 42] were identified for this input parameter, then the code block is processed by running (e.g., executing) the code block with each input value in turn and recording the outcome of each run. That is, the input value 0 is provided for the code block and the outcome recorded, the input value of 1 is provided for the code block and the outcome recorded, etc.

Here, processing the first code block corresponds to causing the functionality of the first code block to be evaluated or realised. As such, processing the first code block can include executing the first code block in accordance with each of the plurality of sets of input values, interpreting the first code block in accordance with each of the plurality of sets of input values, evaluating the first code block in accordance with each of the plurality of sets of input values, and so on. When the first code block corresponds to a portion (e.g., method, function, sub-module, etc.) of a software program, then processing the first code block can involve running, executing, interpreting, etc. the computer program to cause invocation or execution of the first code block. Alternatively, the code block can be invoked or executed independently of the rest of the code of the computer program (e.g., by means of a test or test suite).

The processing of the first code block according to an input value or input values results in the generation of a program state. Throughout the present disclosure, and unless otherwise stated, a program state is understood as the stored information that a computer program (or code block) can access and manipulate such as values of variables, contents of data structures, statuses of various control structures, and the like that determine a specific outcome or state. For example, a code block which has one input parameter and generates a Boolean output may have a program state of {false: [0]} for the observed outcome “false” and the input value 0 (i.e., the input state). A program state can further include statuses of control structures such as CPU registers, memory, I/O devices, and the like. A program state can also include state that is not directly modified by the first code block (e.g., Process Control Blocks and the like). A program state can include multiple input values for a single outcome. Continuing the previous example, the program state may be extended to {false: [0, 1, 10]} when the code block is provided with the input values 1 and 10. Moreover, a code block can realise or generate multiple program states. In the previous example, providing a further input value of 42 to the code block may result in the outcome “true” such that the code block has program state pairs of {false: [0, 1, 10]; true: [42]}. In the present disclosure, a program state for a code block can thus be defined as a combination of an observed outcome of the code block and a set of one or more input values of the input parameters of the code block which resulted in the observed outcome. The one or more outcomes comprise one or more of: return values, values of instance variables, values of static variables, and/or object references. For code blocks with multiple outputs, program states can be recorded for each unique combination of outputs.

At the step of analysing 106, the plurality of program states are analysed to identify a relevant program state generated according to one or more sets of input values of the plurality of sets of input values. The relevant program state comprises one or more outcomes which satisfy a surprisal criterion with respect to the one or more sets of input values.

The plurality of program states generated at the step of processing 104 (as described above) correspond to a dynamically generated set of outcome(s) for a set of corresponding input values. According to an aspect of the present disclosure, the program states are analysed to identify one or more input values and corresponding outcome(s) which are of potential interest and are thus relevant for further analysis or action (e.g., values which can form the basis of further testing or analysis, execution, etc.). The plurality of program states are analysed by identifying a program state within the plurality of program states which is “surprising” in relation to other program states within the plurality of program states. Surprisal, also known as self-information, is a concept from information theory that quantifies the amount of information gained when a particular event occurs; in the present disclosure, the amount of information gained when a particular outcome of the first code block is observed as a result of processing/executing the first code block according to one or more input values. Surprisal measures how surprising or unexpected an event is based on its probability. In the present disclosure, a program state is considered to be surprising if it satisfies a surprisal criterion which is determined based on the information content of the relevant program state.

The information content of a program state is computed according to:

$$I ( {E}_{k} ) = - {log}_{2} {p}_{k} \qquad ( 1 )$$

Where I is the self-information (or surprisal) of event k (Eₖ) and pₖ is the probability of that event occurring. The skilled person will appreciate that bases other than 2 can be used for the logarithm with different bases affecting the scale of the resultant information content. In the context of the present disclosure, event k (Eₖ) corresponds to an outcome of the first code block (as identified by processing the first code block in accordance with the plurality of sets of input values). As such, the information content of an event, or outcome, k is a measure of how much information is gained as a result of the event or outcome occurring. If an event is very rare (i.e., an outcome having a low probability of occurrence) then its occurrence is highly surprising and thus carries more information than a more common event (i.e., an outcome having a high probability of occurrence).

As an example, consider a code block which takes a char input parameter and returns a bool outcome (i.e., true or false). Suppose input values [“a”, “b”, “c”, “d”, “e”, “f” ] were sampled for the input parameter resulting in the program state pairs {false: [“a”, “b”]; true: [“c”, “d”, “e”, “f”]}. The probability of the outcome “false” is

$${p}_{false} = \frac{2}{6}$$

and the probability of the outcome “true” is

$${p}_{true} = \frac{4}{6} .$$

The information content for the two program states is calculated as

$$I ( {E}_{false} ) = - \frac{2}{6} = 1.58 and I ( {E}_{true} ) = - \frac{4}{6} = 0.58 .$$

From this, it can be inferred that the outcome “true” observed for input values “a” and “b” are more surprising, and thus potentially more interesting and appropriate for further analysis, than the other input values/outcome. The information content of the program state is thus a quantifiable and comparable metric which can be used to identify relevant/important program states/input values for further analysis in a computationally efficient manner

The surprisal criterion is associated with a threshold surprisal value such that a program state satisfies the surprisal criterion if it has an information content value which exceeds the threshold surprisal value. The threshold surprisal value can be a predefined value (e.g., 1.0, 1.5, 2.0, etc.) or can be dynamically set according to a rule. For example, the threshold surprisal value can be associated with a specific probability value or percentile. Alternatively, a program state satisfies the surprisal criterion if it has the highest information content value in the set of all information content values calculated for all program states.

In one embodiment, the plurality of program states are analysed by calculating 108 a plurality of information content values and identifying 110 the relevant program state based on information content and the surprisal criterion.

At the step of calculating 108, a plurality of information content values are calculated. An information content value of the plurality of information content values corresponds to the information content of a corresponding program state of the plurality of program states.

That is, an information content value is calculated for each program state generated as a result of processing the code block in accordance with the sets of input values (e.g., using Equation (1)) resulting in a plurality of information content values being calculated (computed or generated). Thus, each program state has a corresponding information content value associated therewith. In one embodiment, the plurality of information content values are calculated in parallel.

At the step of identifying 110, the relevant program state is identified based on a determination that the information value of the relevant program state satisfies the surprisal criterion.

The plurality of information content values are analysed to identify an information content value—and a corresponding program state—which satisfies the surprisal criterion. Each information content value is analysed in turn to identify the information content value and corresponding program state which satisfies the surprisal criterion. Alternatively, the plurality of information content values are sorted according to the magnitude of the information content value in order to identify the information content value and corresponding program state which satisfies the surprisal criterion. For example, sorting the plurality of information content values allows the largest information content value, or information content values above a certain threshold/percentile, to be efficiently identified.

At the step of causing 112, an action in relation to the first code block is caused to be executed based on the relevant program state and/or the one or more sets of input values.

The action comprises causing execution of the first code block based on the relevant program state and/or the one or more sets of input values. In one embodiment, causing execution of the first code block corresponds to executing the first code block.

Additionally, or alternatively, the action comprises generating an artefact derived from the first code block using the relevant program state and/or the one or more sets of input values. The artifact comprises one or more code statements for use within the first code block. Additionally, or alternatively, the artefact comprises one or more code statements for use within a second code block. In one embodiment, the second code block is a test for the first code block. The one or more code statements include a name for the test.

Additionally, or alternatively, the action comprises modifying one or more code statements based on the relevant program state and/or the one or more sets of input values. Modifying the one or more code statements comprises removing the one or more code statements from the first code block. Additionally, or alternatively, modifying the one or more code statements comprises prioritising the one or more code statements within the first code block. In one embodiment, the one or more code statements are within the first code block. Alternatively, the one or more code statements are within a second code block associated with the first code block. The one or more code statements correspond to assertions within a test for the first code block.

Additionally, or alternatively, the action comprises performing a further analysis or test of the first code block based on the relevant program state and/or the one or more sets of input values. For example, the relevant program state and/or the one or more sets of input values can be used as basis for a more complete analysis of the first code block (e.g., cover analysis or the like). The method 100 therefore provides a computationally efficient initial screen of potential input values/program states to identify relevant program states and corresponding input values which can then be used for more computationally expensive analysis approaches.

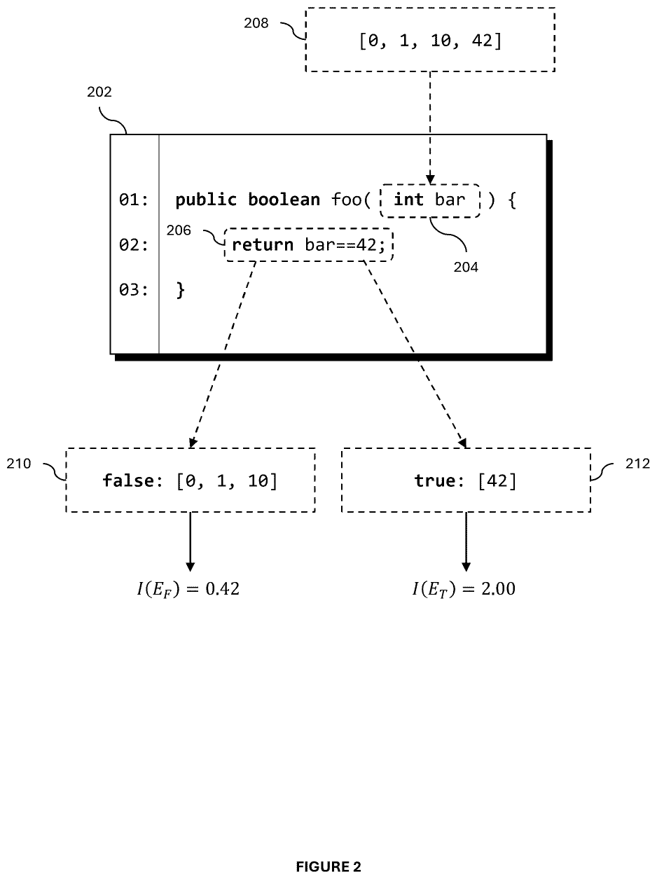

FIG. 2 shows an illustrative example of program state relevancy assessment according to embodiments of the present disclosure.

FIG. 2 shows a code block 202 comprising an input parameter 204 and an output statement 206. FIG. 2 further shows a plurality of input values 208 for the input parameter 204, a first program state 210, and a second program state 212.

The code block 202 is a method which takes a single parameter—the input parameter 204—as input and returns a Boolean output depending on the evaluation of the output statement 206. The output statement 206 evaluates to “true” when the value provided for the input parameter 204 is equal to 42. It is relatively straight forward to determine, based on a manual evaluation of the code block 202, that there are two possible cases worth testing, with the most important being when the value provided for the input parameter 204 is 42. However, existing automated dynamic analysis approaches would struggle to identify this efficiently.

According to the present disclosure, the plurality of input values 208 are sampled for the input parameter 204 resulting in the generation of the first program state 210 and the second program state 212. The first program state 210 corresponds to the program state when the output statement 206 evaluates to “false” and is observed for the subset of the plurality of input values 208 [0, 1, 10]. The information content value calculated for the first program state 210 is 0.42. The second program state 212 corresponds to the program state when the output statement 206 evaluates to “true” and is observed for the value 42 within the plurality of input values 208. The information content value calculated for the second program state 212 is 2.00.

In this example, there is much more information contained when the output statement 206 evaluates to true (i.e., the second program state 212) compared to when the output statement 206 evaluates to false (i.e., the first program state 210). Consequently, because the second program state 212 is surprising—that is, the information content for the second program state 212 satisfies a surprisal criterion—the second program state 212 can be analysed in further detail. For example, a more computationally expensive technique can be executed to cover/test all paths. In contrast, because the first program state 210 is not surprising—that is, the information content for the first program state 210 does not satisfies the surprisal criterion—the first program state 210 need not be analysed in further detail. Therefore, the information content of a program state is used to determine whether or not a program state warrants further analysis therefore ensuring that computational resources are maintained for scenarios/states which are more likely to yield useful and interesting results.

In some embodiments, a subset of the program states which do not meet the surprisal criterion are analysed. That is, some of the unsurprising program states are analysed but they may be analysed using at the same level of detail as the program states which do meet the surprisal criterion.

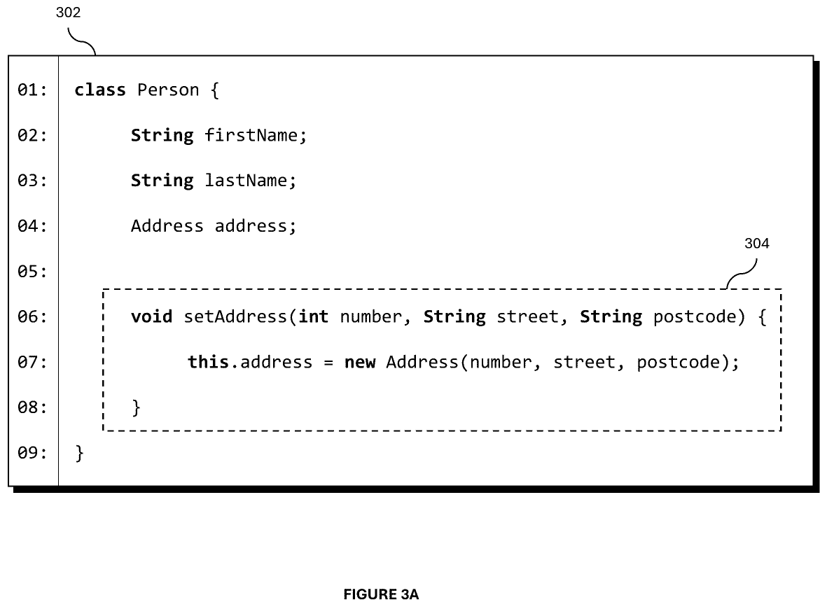

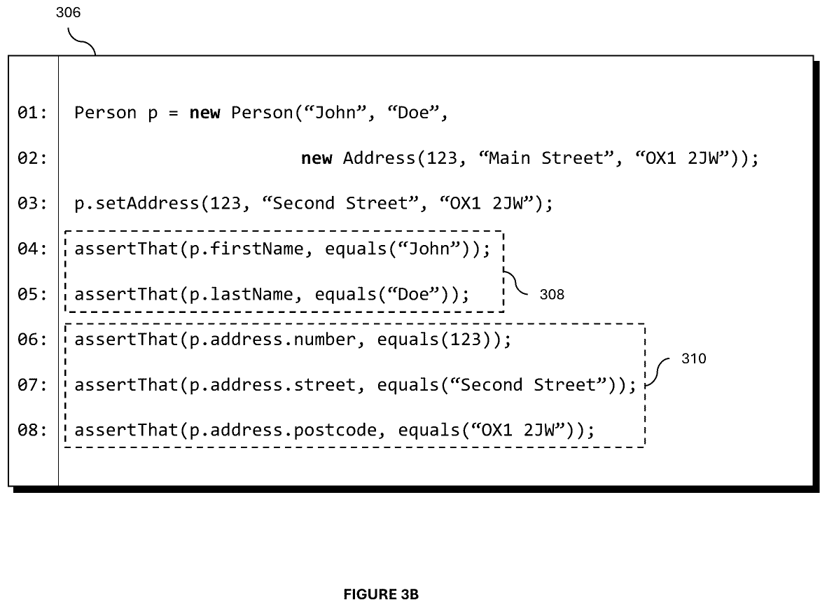

FIGS. 3A and 3B show an illustrative example of program state relevancy assessment for assertion selection according to embodiments of the present disclosure.

FIG. 3A shows a source code listing 302 for a Person class. The Person class has three fields—a first name field of type String, a last name field of type String, and an address field of type Address. The source code listing 302 shows a method 304 of the Person class (setAddress), which sets the address field given the number, street name, and postcode which are provided as input parameters to the method. The skilled person will appreciate that the Person class may comprise further methods (e.g., a constructor, getter/setter methods for the other fields, processing logic, etc.) which are not shown in the source code listing 302 for brevity.

FIG. 3B shows a code block 306 comprising a series of assertions for testing the method 304 shown in the source code listing 302 of FIG. 3A. In lines 01-02 of the code block 306, a new object of type Person is created with field values “John”, “Doe”, (123, “Main Street”, “OX1 2JW”) for the first name, last name, and address fields respectively. In line 03 of the code block 306, the address of the Person object is changed to (123, “Second Street”, “OX1 2JW”). The code block 306 then comprises a first set of assertions 308 and a second set of assertions 310. The first set of assertions 308 relate to the first name and last name fields of the Person object whilst the second set of assertions 310 relate to the address field of the Person object.

The first name and last name fields of a Person object can never be modified by the setAddress method. As shown in the source code listing 302 of FIG. 3A, the method 304 only sets the address field of a Person object. Therefore, when computing the information content for tests involving the first name and last name, the value would be undefined because the log of 0 is not computable. The skilled person will appreciate that in such circumstances, the information content would be set to 0. In contrast, the information content for tests involving the address would be non-zero. As such, the assertions in the first set of assertions 308 would each have an information content of 0, whilst the assertions in the second set of assertions 310 would each have a non-zero information content. In this case, the number and postcode assertions on lines 06 and 08 would have low information content whilst the street assertion on line 07 would have a high information content because of the change in the object reference (essentially, it points to a different memory location while keeping the data contained within the object the same).

The information content associated with each assertion in the first set of assertions 308 and the second set of assertions 310 can then be used to filter the list of assertions and modify the code block 306. That is, because the first set of assertions 308 have an information content of 0, they can be deleted from the code block 306 whilst the second set of assertions 310 are maintained because they have a non-zero information content.

Moreover, the example shown in FIGS. 3A and 3B illustrate how the information content of program states can be used to construct test names. As stated above, the change of the street field of the address from “Main Street” to “Second Street” results in a high information content value. The high information content indicates that the given input values are relevant for testing and so the input values—“Main Street” and “Second Street”—can be used to generate a human readable test name. The test name is generated according to the Given-When-Then naming style. The skilled person will appreciate that other naming styles may be used.

The sections of the Given-When-Then structure can be automatically identified in a number of ways. For example, the program state prior to the change of address can be used to generate the “given” section, the name of the class/object being changed (i.e., Address) can be used to generate the “when” section, and the input value provided to the assertion can be used to generate the “then” section. That is, the test name would be “testSetAddress_givenStreetIsMainStreet_whenAddressChanges_thenStreetIsSecondStreet”. This provides a more understandable, and user friendly, name than a naïve alternative (e.g., “testSetAddress”, “test1”, etc.). As an alternative example, if the code is represented in an intermediate or abstract representation (e.g., syntax tree) then the sections of the Given-When-Then structure can be identified from the different branches or sub-trees within a tree-based representation.

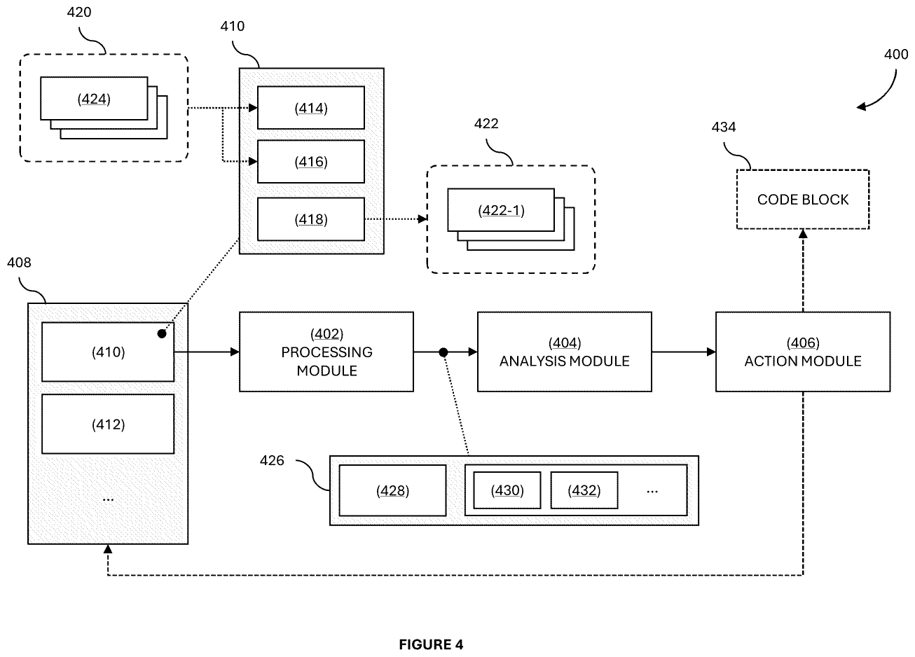

FIG. 4 shows a system 400 for program state relevancy assessment according to an aspect of the present disclosure.

The system 400 comprises a processing module 402, an analysis module 404, and an action module 406. FIG. 4 further shows a computer program 408 comprising a first code block 410 and a second code block 412. The first code block 410 comprises a first code statement 414, a second code statement 416, and a third code statement 418. FIG. 4 also shows a plurality of sets of input values 420 and a plurality of outcomes 422. The plurality of sets of input values 420 comprise a first set of input values 424 and the plurality of outcomes 422 comprise a first outcome 422-1 associated with the first set of input values 424. FIG. 4 further shows a program state 426 which comprises an outcome 428 and a plurality of sets of input values including a second set of input values 430 and a third set of input values 432. A generated code block 434 is also shown in FIG. 4.

The processing module 402 is configured to obtain a code block and identify sets of input values for input parameters of the code block. For example, the processing module 402 obtains the first code block 410 and identifies the plurality of sets of input values 420 for the input parameters associated with the first code statement 414 of the first code block 410 and the second code statement 416 of the first code block 410. The processing module 402 identifies sets of input values using any suitable approach such as those described herein (e.g., random sampling, systematic sampling, dynamic sampling, etc.). Throughout the following description, reference will be made to the processing of the first code block 410. However, the skilled person will appreciate that the operations of the system 400 is not limited to the first code block 410 and the operations performed by the system 400 may be performed in relation to any other code block (e.g., the second code block 412).

The processing module 402 is further configured to generate a plurality of outcomes by processing (e.g., executing or invoking) the first code block 410 in accordance with each of the plurality of sets of input values 420. For example, the first outcome 422-1 of the plurality of outcomes 422 is generated by processing the first code block 410 in accordance with the first set of input values 424. That is, the first set of input values 424 are provided to the input parameters associated with the first code statement 414 of the first code block 410 and the second code statement 416 of the first code block 410. The plurality of outcomes 422 corresponds to the outcomes observed/generated as a result of processing the first code block 410 in accordance with each of the plurality of sets of input values 420. As such, each set of input values is associated with an outcome. The processing module 402 groups input values and outcomes into two or more program states. Here, a program state is a combination of an observed outcome of the code block and a set of one or more input values of the input parameters of the code block which resulted in the observed outcome. That is, a program state comprises one or more outcomes associated with an invocation of the first code block 410 using a respective set of input values for the one or more input parameters of the first code block 410. For example, the outcome 428 of the program state 426 was observed as a result of executing/processing/invoking a code block (e.g., the first code block 410) in accordance with each of the plurality of input values of the program state 426—e.g., the second set of input values 430, the third set of input values 432, etc. The skilled person will appreciate that whilst FIG. 4 illustrates only a single program state, processing the first code block 410 in accordance with the plurality of sets of input values 420 can result in the generation of a plurality of different program states.

The plurality of program states generated by the processing module 402 are then analysed by the analysis module 404 to identify a relevant program state which was generated according to one or more sets of input values of the plurality of sets of input values. The analysis module 404 is configured to identify the relevant program state by applying a surprisal criterion such that the relevant program state comprises an outcome which satisfies the surprisal criterion with respect to the program state's input values. The surprisal criterion is evaluated by calculating the information content of each program state as shown in Equation (1). As described in more detail above, if an outcome is very rare then its occurrence is highly surprising and thus carries more information than a more common outcome.

The action module 406 is configured to cause an action in relation to the first code block 410 to be executed based on the relevant program state and/or the one or more sets of input values of the relevant program state. For example, the action module 406 may generate a new code block, such as the generated code block 434, based on the relevant program state. Additionally, or alternatively, the action module 406 may generate an artefact derived from the first code block 410 such as code statements, a test, a name for a test, or the like. Additionally, or alternatively, the action module 406 may modify or remove code statements from an existing code block such as the first code block 410.

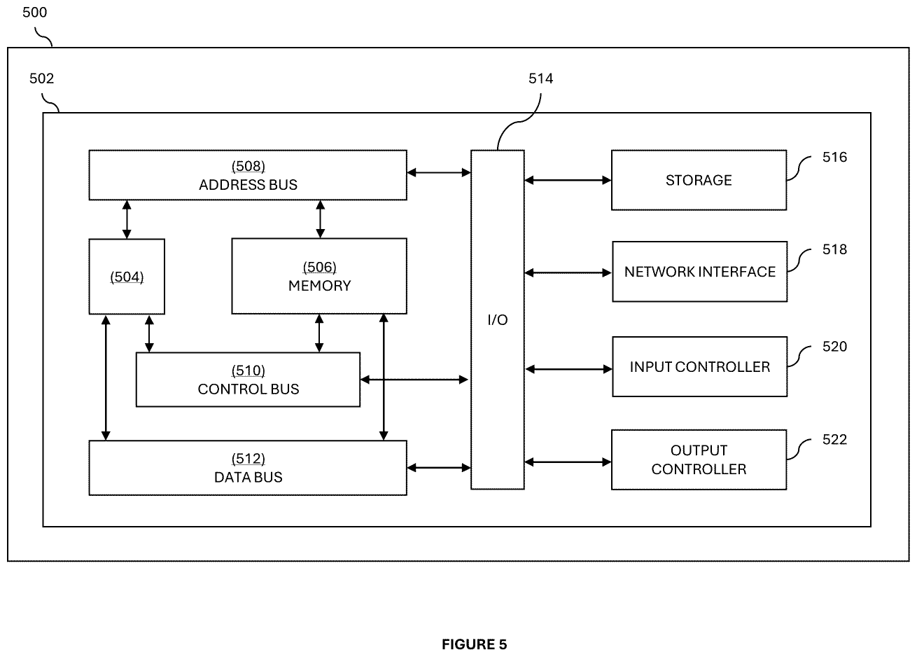

FIG. 5 shows an example computing system for carrying out the methods of the present disclosure. Specifically, FIG. 5 shows a block diagram of an embodiment of a computing system according to example embodiments of the present disclosure. The computing system shown in FIG. 5 may correspond to a part, or the whole, of any of the functional units or modules described above.

Computing system 500 can be configured to perform any of the operations disclosed herein such as, for example, any of the operations discussed with reference to the method steps described in relation to FIG. 1. Computing system includes one or more computing device(s) 502. The one or more computing device(s) 502 of computing system 500 comprise one or more processors 504 and memory 506. One or more processors 504 can be any general purpose processor(s) configured to execute a set of instructions, such as computing instructions including implemented in any one or more programming languages such as Python, Go, C, C++, C#, Java, or the like. For example, one or more processors 504 can be one or more general-purpose processors, one or more field programmable gate array (FPGA), and/or one or more application specific integrated circuits (ASIC). In one embodiment, one or more processors 504 include one processor. Alternatively, one or more processors 504 include a plurality of processors that are operatively connected. One or more processors 504 are communicatively coupled to memory 506 via address bus 508, control bus 510, and data bus 512. Memory 506 can be a random access memory (RAM), a read only memory (ROM), a persistent storage device such as a hard drive, an erasable programmable read only memory (EPROM), and/or the like. The one or more computing device(s) 502 further comprise I/O interface 514 communicatively coupled to address bus 508, control bus 510, and data bus 512.

Memory 506 can store information that can be accessed by one or more processors 504. For instance, memory 506 (e.g., one or more non-transitory computer-readable storage mediums, memory devices) can include computer-readable instructions (not shown) (e.g., computing instructions) that can be executed by one or more processors 504. The computer-readable instructions can be software written in any suitable programming language or can be implemented in hardware. Additionally, or alternatively, the computer-readable instructions can be executed in logically and/or virtually separate threads on one or more processors 504. For example, memory 506 can store instructions (not shown), such as computing instructions, that when executed by one or more processors 504 cause one or more processors 504 to perform operations such as any of the operations and functions for which computing system 500 is configured, as described herein. In addition, or alternatively, memory 506 can store data (not shown) that can be obtained, received, accessed, written, manipulated, created, and/or stored. The data can include, for instance, the data and/or information described herein in relation to FIGS. 2-4. In some implementations, the one or more computing device(s) 502 can obtain from and/or store data in one or more memory device(s) that are remote from the computing system 500.

Computing system 500 further comprises storage unit 516, network interface 518, input controller 520, and output controller 522. Storage unit 516, network interface 518, input controller 520, and output controller 522 are communicatively coupled to the central control unit (i.e., the memory 506, the address bus 508, the control bus 510, and the data bus 512) via I/O interface 514.

Storage unit 516 is a computer readable medium, preferably a non-transitory computer readable medium, comprising one or more programs, the one or more programs comprising computing instructions which when executed by the one or more processors 504 cause computing system 500 to perform the method steps of the present disclosure. Alternatively, storage unit 516 is a transitory computer readable medium. Storage unit 516 can be a persistent storage device such as a hard drive, a cloud storage device, or any other appropriate storage device.

Network interface 518 can be a Wi-Fi module, a network interface card, a Bluetooth module, and/or any other suitable wired or wireless communication device. In an embodiment, network interface 518 is configured to connect to a network such as a local area network (LAN), or a wide area network (WAN), the Internet, or an intranet.

In the present disclosure, references to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth. The use of any and all examples, or exemplary language (“e.g.,” “such as,” “including,” or the like) provided herein, is intended merely to better illuminate the embodiments and does not pose a limitation on the scope of the embodiments or the claims.

For consistency and ease of reference, the present disclosure is described primarily in relation to the Java programming language. However, the skilled person will appreciate that the systems and methods of the present disclosure are not limited as such. Indeed, the systems and methods of the present disclosure are applicable to any suitable programming language or environment, including but not limited to Java, C, C++, any suitable assembly language, Python, C#, JavaScript, Ruby, PHP, and the like.

Some embodiments described herein may relate to a computer storage product with a non-transitory computer-readable medium (also can be referred to as a non-transitory processor-readable medium) having instructions or computer code thereon for performing various computer implemented operations. The computer-readable medium (or processor readable medium) is non transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a transitory computer program product, which can include, for example, the instructions and/or computer code discussed herein.

Some embodiments and/or methods described herein can be performed by software (executed on hardware), hardware, or a combination thereof. Hardware modules include, for example, a general-purpose processor, a field programmable gate array (FPGA), and/or an application specific integrated circuit (ASIC). Software modules (executed on hardware) can be expressed in a variety of software languages (e.g., computer code), including C, C++, Java, Ruby, Visual Basic, Python, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

The above illustrative examples of various aspects and implementations provide an overview for understanding aspects and implementation of the disclosed method. The figures provided herein depict exemplary aspects of the present system and methods and are not intended to limit the scope of the disclosure.

What is claimed is:

1. A method comprising:
identifying, by one or more processors, a plurality of sets of input values for one or more input parameters of a first code block;
processing, by the one or more processors, the first code block in accordance with each of the plurality of sets of input values thereby generating a plurality of program states, wherein a respective program state of the plurality of program states comprises one or more outcomes associated with an invocation of the first code block using a respective set of input values for the one or more input parameters of the first code block;
analysing, by the one or more processors, the plurality of program states to identify a relevant program state generated according to one or more sets of input values of the plurality of sets of input values, wherein the relevant program state comprises one or more outcomes which satisfy a surprisal criterion with respect to the one or more sets of input values; and
causing, by the one or more processors, an action in relation to the first code block to be executed based on the relevant program state and/or the one or more sets of input values.

2. The method of claim 1 wherein the action comprises causing execution of the first code block based on the relevant program state and/or the one or more sets of input values.

3. The method of claim 1 wherein the action comprises generating an artefact derived from the first code block using the relevant program state and/or the one or more sets of input values.

4. The method of claim 3 wherein the artifact comprises one or more code statements for use within the first code block.

5. The method of claim 3 wherein the artefact comprises one or more code statements for use within a second code block.

6. The method of claim 5 wherein the second code block is a test for the first code block.

7. The method of claim 6 wherein the one or more code statements include a name for the test.

8. The method of claim 1 wherein the action comprises modifying one or more code statements based on the relevant program state and/or the one or more sets of input values.

9. The method of claim 8 wherein modifying the one or more code statements comprises removing the one or more code statements from the first code block or prioritising the one or more code statements within the first code block.

10. The method of claim 8 wherein the one or more code statements are within the first code block or a second code block associated with the first code block.

11. The method of claim 10 wherein the one or more code statements correspond to assertions within a test for the first code block.

12. The method of claim 1 wherein the surprisal criterion is determined based on the information content of the relevant program state.

13. The method of claim 12 wherein the step of analysing comprises:
calculating, by the one or more processors, a plurality of information content values, wherein an information content value of the plurality of information content values corresponds to the information content of a corresponding program state of the plurality of program states;
identifying, by the one or more processors, the relevant program state based on a determination that the information value of the relevant program state satisfies the surprisal criterion.

14. The method of claim 1 wherein the plurality of sets of input value are identified using a sampling strategy.

15. The method of claim 14 wherein the sampling strategy comprises sampling values across the range of possible values for the one or more input parameters or sampling values dynamically derived from previous sampling results.

16. The method of claim 1 wherein the set of input values comprise one or more of: values of instance variables, values of static variables, and/or object references.

17. The method of claim 1 wherein the one or more outcomes comprise one or more of: return values, values of instance variables, values of static variables, and/or object references.

18. The method of claim 1 wherein the step of processing the first code block comprises executing the first code block in accordance with each of the plurality of sets of input values.

19. A device comprising one or more processors and a memory storing instructions which, when executed by the one or more processors, cause the one or more processors to:
identify a plurality of sets of input values for one or more input parameters of a code block;
process the code block in accordance with each of the plurality of sets of input values thereby generating a plurality of program states, wherein a respective program state of the plurality of program states comprises one or more outcomes associated with an invocation of the code block using a respective set of input values for the one or more input parameters of the code block;
analyse the plurality of program states to identify a relevant program state generated according to one or more sets of input values of the plurality of sets of input values, wherein the relevant program state comprises one or more outcomes which satisfy a surprisal criterion with respect to the one or more sets of input values; and
cause an action in relation to the code block to be executed based on the relevant program state and/or the one or more sets of input values.

20. A non-transitory computer readable medium storing instructions which, when executed by one or more processors, cause the one or more processors to:
identify a plurality of sets of input values for one or more input parameters of a code block;
process the code block in accordance with each of the plurality of sets of input values thereby generating a plurality of program states, wherein a respective program state of the plurality of program states comprises one or more outcomes associated with an invocation of the code block using a respective set of input values for the one or more input parameters of the code block;
analyse the plurality of program states to identify a relevant program state generated according to one or more sets of input values of the plurality of sets of input values, wherein the relevant program state comprises one or more outcomes which satisfy a surprisal criterion with respect to the one or more sets of input values; and
cause an action in relation to the code block to be executed based on the relevant program state and/or the one or more sets of input values.
